(19) United States
(12) Patent Application Publication
(10) Pub. No.: US 2018/0366097 A1
(43) Pub. Date: Dec. 20, 2018

(54) METHOD AND SYSTEM FOR AUTOMATICALLY GENERATING LYRICS OF A SONG

(71) Applicant: Kent E. Lovelace, Gulfport, MS (US)

(72) Inventor: Michael Sharp, Porter, TX (US)

(21) Appl. No.: 15/981,387

(22) Filed: May 16, 2018

Related U.S. Application Data
(60) Provisional application No. 62/519,466, filed on Jun. 14, 2017.

(51) Int. Cl. G10H 1/36; G06Q 30/02; G10L 15/00; G10L 15/08; G10L 15/22; G10H 1/46; G10L 25/81; G10L 25/90

(52) U.S. Cl. CPC G10H 1/361; G06Q 30/0269; G10L 15/005; G10L 15/08; G06N 3/08; G10H 1/46; G10L 25/81; G10L 25/90; G10L 15/22

(57) ABSTRACT

A method and system for automatically generating the lyrics of a song is provided to reduce the time and cost of song transcription. The method may include isolating vocal content from instrumental content for a provided audio input. The vocal content may be processed or normalized to obtain a natural vocal content. A speech recognizer may then be utilized to transcribe a plurality of words of the natural vocal content. The plurality of words may then be organized and saved as a lyric time code. The lyric time code may be stored with an audio file or used to generate dynamic outputs associated with the vocal content. The system may include hardware and software to provide deep neural networks used by artificial intelligence to carry out steps of the method.

The current application claims a priority to the U.S. Provisional Patent Application Ser. No. 62/519,466 filed on Jun. 14, 2017.

### FIELD OF THE INVENTION

The present invention relates generally to the field of audio processing. More specifically, the present invention relates to methods and systems for facilitating automatic generation of lyrics of songs using speech recognition.

### BACKGROUND OF THE INVENTION

Music continues to be one of the most widely consumed forms of content in the digital age. It has been estimated that about 50-60% of media revenue is attributable to the music industry. The digital music industry alone has been estimated to be over 5 billion USD as of 2015. Accordingly, technologies have significantly evolved to facilitate creation, processing, storage and distribution of music to users worldwide in a manner that enhances the overall experience of users.

A large portion of music currently consumed by users includes vocal content sung by one or more singers in one or more natural languages. However, owning to various factors, such as presence of background instrumental music, an accent of the singer, pitch/melody, style of singing, etc., users often face difficulty in comprehending the vocal content of songs. Accordingly, music publishers often provide lyrics associated with the vocal content along with the song.

However, although the lyrics for a song may be available with a creator and/or publisher of a song, due to the nature of existing music distribution and in particular the Internet, users often struggle with a lack of access to lyrics of songs. As a result, several web-based services have come into existence in the past few years that specifically aim to provide users with lyrics of songs. Typically, such web-based services operate by utilizing skilled human resources who painstakingly listen to songs and manually transcribe the vocal content. The lyrics thus obtained is subsequently made available over the Internet to users. However, the manual transcription of vocal content is a time consuming and expensive endeavor, thus leading to increased company cost which may be passed along to the consumer.

As may be evident, there are several problems with the existing methods of generating lyrics. Firstly, since human efforts are involved, it places constraints on the number of songs that may be transcribed by a given set of individuals. Secondly, it places auditory and/or cognitive burden on users who are required to listen to songs for long periods of time with high levels of attention. Thirdly, in spite of employing skilled individuals, errors in the lyrics generated by people are common. Fourthly, the use of human labor to transcribe song lyrics and create lyric time codes incurs a large overhead cost. Fifthly, manually transcribing song lyrics and creating lyric time codes is an arduous process, wherein a large quantity of time is dedicated to a single song.

Accordingly, there is a need for methods and systems for automatically and accurately generating lyrics of a song. As such, it is an object of the present invention to provide a method and system for automating the generation of lyrics of a song. It is an object of the present invention to reduce the transcription time of a song. It is further an object of the present invention to reduce the cost of transcribing a song. Furthermore, it is an object of the present invention to provide a means for generating dynamic outputs associated with the lyrics of a song.

### SUMMARY OF THE INVENTION

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

In accordance with some embodiments, the present disclosure also provides a first method of automatically generating lyrics of a song. The first method may include a step of receiving, using the communication device, an audio input of a song having both musical elements and vocal content. Further, the first method may include a step of isolating, using the processing device, the vocal content from the musical elements. Furthermore, the first method may include a step of normalizing, using the processing device, the vocal content in order to obtain a natural vocal content. Further, the first method may include a step of transcribing, using the processing device, a plurality of words from the natural vocal content using speech recognition software. Furthermore, the first method may include a step of generating, using the processing device, a lyric time code for the song using the plurality of words.

In accordance with some embodiments, the present disclosure provides a second method of automatically generating lyrics of a song. The second method may include a step of receiving, using a communication device, a music file comprising a song. Further, the second method may include a step of extracting, using a processing device, a vocal content from the music file. Furthermore, the second method may include a step of determining, using the processing device, a melody corresponding to the vocal content. Additionally, the second method may include a step of performing, using the processing device, pitch normalization of the vocal content based on the melody to obtain a natural vocal content. Further, the second method may include a step of performing, using the processing device, speech recognition of the natural vocal content to obtain lyrics corresponding to the vocal content. Furthermore, the second method may include a step of transmitting, using the communication device, the lyrics and the melody to a user device for presentation.

In accordance with some embodiments, the present disclosure also provides a third method of automatically generating lyrics of a song. The third method may include a step of receiving, using the communication device, a music file comprising a song. Further, the third method may include a step of analyzing, using the processing device, the music file to determine at least one of a song characteristic and a singer characteristic associated with the song. Furthermore, the third method may include a step of determining, using the processing device, a melody corresponding to the vocal content. Additionally, the third method may include a step of performing, using the processing device, pitch normalization of the vocal content based on the melody to obtain a natural vocal content. Further, the third method may include a step of selecting, using the processing device, a speech recognizer based on at least one of the song characteristic, the singer characteristic and the melody. Furthermore, the third method may include a step of performing, using the processing device, speech recognition of the natural vocal content using the selected speech recognizer to obtain lyrics corresponding to the vocal content.

In accordance with some embodiments, the present disclosure provides a first system for automatically generating lyrics of a song. The first system may include a communication device configured for receiving a music file comprising a song. Further, the communication device may be configured for transmitting lyrics and the melody to a user device for presentation. Additionally, the first system may include a processing device configured for extracting a vocal content from the music file. Furthermore, the processing device may be configured for determining a melody corresponding to the vocal content. Additionally, the processing device may be configured for performing pitch normalization of the vocal content based on the melody to obtain a natural vocal content. Further, the processing device may be configured for performing speech recognition of the natural vocal content to obtain the lyrics corresponding to the vocal content.

In accordance with some embodiments, the present disclosure also provides a second system for automatically generating lyrics of a song. The second method may include a communication device configured for receiving a music file comprising a song. Additionally, the communication device may be configured for transmitting lyrics and the melody to a user device for presentation. Further, the second system may include a processing device configured for analyzing the music file to determine at least one of a song characteristic and a singer characteristic associated with the song. Furthermore, the processing device may be configured for determining, using the processing device, a melody corresponding to the vocal content. Additionally, the processing device may be configured for performing pitch normalization of the vocal content based on the melody to obtain a natural vocal content. Further, the processing device may be configured for selecting a speech recognizer based on at least one of the song characteristic, the singer characteristic and the melody. Furthermore, the processing device may be configured for performing speech recognition of the natural vocal content using the selected speech recognizer to obtain lyrics corresponding to the vocal content.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of a platform consistent with various embodiments of the present disclosure;

FIG. 2 is an illustration of an output generated by the system of the present disclosure, in accordance with some embodiments;

FIG. 3 is a flowchart of a method of automatically generating lyrics of a song, in accordance with some embodiments;

FIG. 4 is a flowchart of a method of automatically generating lyrics of a song based on at least one of a song characteristic and a singer characteristic, in accordance with some embodiments; and

FIG. 5 is a block diagram of a computing device (also referred to herein as a processing device) for implementing the methods disclosed herein, in accordance with some embodiments.

FIG. 6 is a flowchart of a method of automatically generating lyrics of a song, in accordance with some embodiments.

FIG. 7 is a flowchart of processing an audio input in order to obtain a lyric time code, in accordance with some embodiments.

FIG. 8 is an illustration of a lyric time code output by the system of the present disclosure, in accordance with some embodiments.

FIG. 9 is an illustration of a dynamic output generated by the system of the present disclosure, wherein the dynamic output is an image of an object corresponding to two of the plurality of words.

FIG. 10 is an illustration of a dynamic output generated by the system of the present disclosure, wherein the dynamic output is a visual representation of two of the plurality of words.

FIG. 11 is an illustration of a dynamic output generated by the system of the present disclosure, wherein the dynamic output is a hologram representation of two of the plurality of words.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of generation of lyrics of songs, embodiments of the present disclosure are not limited to use only in this context. For example, the disclosed techniques may be used to perform audio transcription in general and for example, of speech in dialects.

The present invention is a method and system for automatically generating the lyrics of a song, wherein the lyrics can be output in a visual manner. In a generalized overview, the method of the present invention implements the following steps: 1) receiving an audio input 700, wherein the audio input 700 is of a song having instrumental content 702 and vocal content 704; 2) isolating the vocal content 704 from the instrumental content 702; 3) normalizing the vocal content 704 in order to obtain a natural vocal content 706; 4) transcribing a plurality of words 708 from the natural vocal content 706 using a speech recognition software; and 5) generating a lyric time code 710 for the song using the plurality of words 708. The lyric time code 710 can then be used to produce a variety of visual outputs associated with the content of the song.

According to an exemplary embodiment, the present disclosure provides a method of generating lyrics of a song, as outlined in the following steps; 1) A user accesses a software on a phone, tablet, or other computing device. The user selects a song from any available source on a local drive of the computing device, a network, or an output device (e.g. a speaker) of the computing device or a second computing device such as a cell phone or tablet (the software will also allow for dynamic listening from the output device); 2) Once the song is selected, a first algorithm process reduces all music volume in the song and isolates vocal content 704 from instrumental content 702, thus creating the ability for a second algorithm process to determine the melody and pitch of each note being sung by the vocalist(s); 3) Once all the notes of the song's melody are determined, they are then stored in temporary memory; 4) Subsequently, a third algorithm process copies the stored notes and converts all notes to key of C in essence all notes are now monotone with a note value of C; 5) Thereafter, a fourth algorithm process generates the lyric time code 710 by converting each word to text and adding the notes that are saved in temporary memory, wherein the information is displayed in a real time fashion displayable on the user's computing device, cellphone or other electronic display.

According to an exemplary embodiment, one or more of the following actions can be taken once the lyric time code 710 has been generated: 1) Lyrics can be verified and edited automatically with popular lyric databases and edited by an algorithm that searches lyric archives and matches the most popular lyrics with the generated lyrics on a word by word comparison, selecting the most popular words substituted for display and storage; 2) All of the data from lyric and melody extraction can be saved for future display and distribution to the user's network of digital devices that have display capability; 3) Revenue can be generated each time a lyric has been displayed with programmatic advertising that can prioritize more value for trending songs by giving a higher value for the most popular songs and thus generating more money per advertising display associated with the available inventory of dynamic lyric conversions; 4) Stored lyric and melody data can be shared and exchanged by way of decentralized access to the user's own computing device across internet/networks, wherein data can edited by social interaction for proof and reproof of accurateness; or 5) Social commentator capability is provided to users offering the ability to input user comments on what the lyrics might mean to each user, songwriter, or publisher, comments on meta data information, etc.

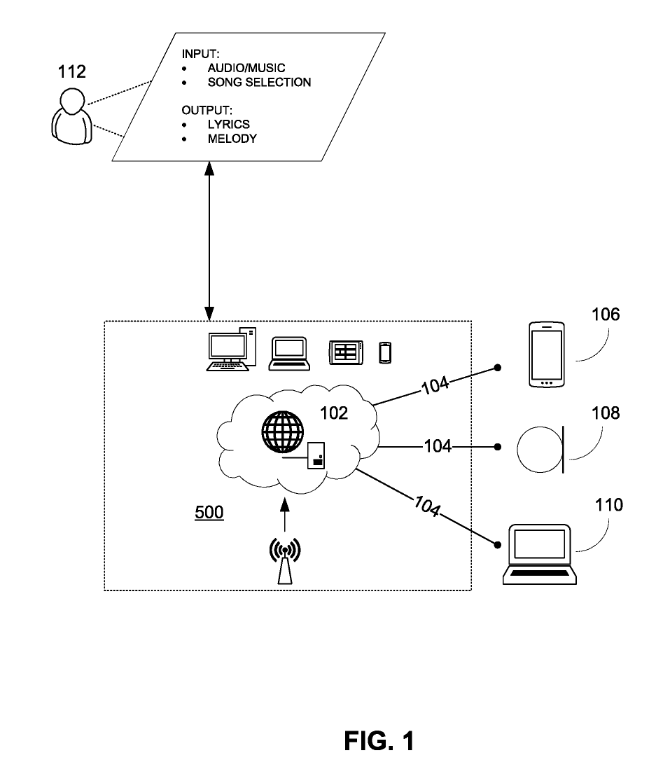

FIG. 1 is an illustration of an online platform 100 consistent with various embodiments of the present disclosure. By way of non-limiting example, the online platform 100 for automatic generation of lyrics may be hosted on a centralized server 102, such as, for example, a cloud computing service. The centralized server 102 may communicate with other network entities, such as, for example, a mobile device 106 (such as a smartphone, a laptop, a tablet computer etc.), a wireless microphone 108 and other electronic devices 110 (such as desktop computers, server computers etc.) over a communication network 104, such as, but not limited to, the Internet. Further, users of the platform may include relevant parties such as one or more of musicians, song writers, singers, music listeners, music learners, music publishers/distributors and so on. Accordingly, electronic devices operated by the one or more relevant parties may be in communication with the platform. For example, the mobile device 106 may be operated by a consumer of music files. Accordingly, the music files may be either stored on a storage device comprised in the mobile device 106 or streamed from a content server (not shown in the figure). Alternatively, the mobile device 106 may be used to record the music being played live and/or on a sound source such as radio, television etc.

A user 112, such as the one or more relevant parties, may access platform 100 through a software application. The software application may be embodied as, for example, but not be limited to, a website, a web application, a desktop application, and a mobile application compatible with a computing device 500.

Accordingly, in an instance, the user 112 may access the platform in order to automatically generate lyrics of a song, wherein an audio input 700 of the song is provided. The user 112 may provide the audio input 700 by uploading a music file (e.g. a software file with a file extension such as .mp3, .wav, .mp4, .avi, etc.) comprising the song to the platform 100. Alternatively, the user 112 may provide the audio input 700 by indicating a song selection by providing a source of the music file online, such as a hyperlink to a media delivery service (e.g. a music streaming website), to the platform 100. As yet another alternative, the software application may acquire the audio input 700 through a microphone of the computing device 500.

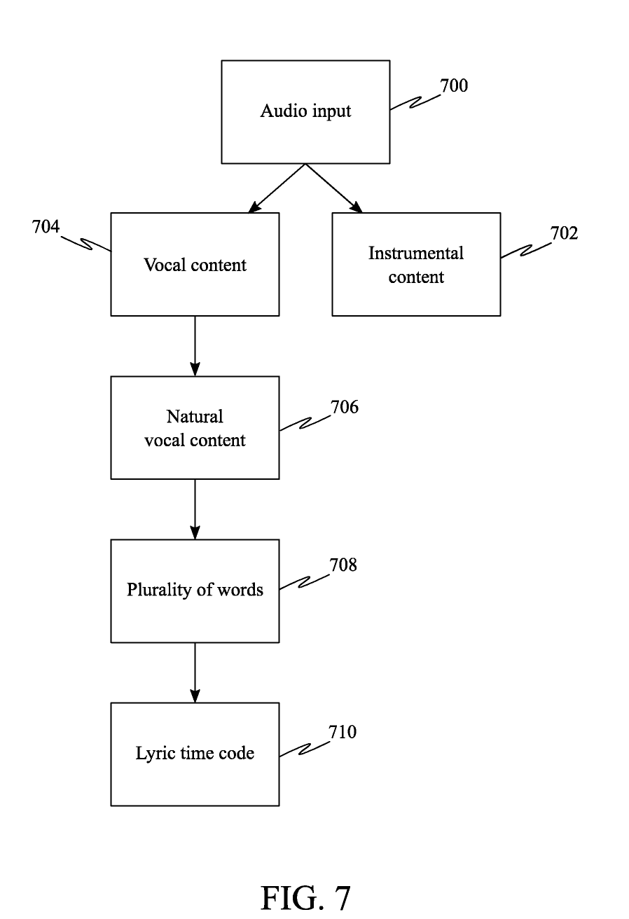

Subsequently, the platform may process the audio input 700 in order to isolate vocal content 704 of the song from instrumental content 702 of the song, as depicted in FIG. 7. In an instance, the instrumental content 702 and the vocal content 704 of the song may be stored in the music file on different tracks or channels. Accordingly, the platform 100 may extract the vocal content 704 by retrieving the corresponding track. In another instance where the music file comprises a single track, the platform may be configured to perform separation of the vocal content 704 from the instrumental content 702 based on acoustic characteristics. Accordingly, since vocals are characterized by acoustic characteristics distinct from that of musical instruments, the platform may be able to separate the vocal content 704 from the instrumental content 702.

Subsequently, the platform 100 may process the vocal content 704 in order to determine a melody of the song. In an instance, the melody may be determined based on identifying and tracking a group of dominant frequencies in the vocal content 704. Further, the dominant frequencies may collectively contain a major portion of energy of the vocal content 704. In some embodiments, the melody may be extracted more reliably from the instrumental content 702 in the music file that correlate with the vocal content 704. In other words, there may be instances where the instrumental content 702 may correspond to one or more musical instruments producing the same melody as that of the vocal content 704, at least in some parts of the music file. Accordingly, by identifying and extracting the instrumental content 702 that correlate with the vocal content 704, extraction of the melody from the instrumental content 702 may be performed with a greater degree of accuracy.

Thereafter, the platform 100 may perform a pitch normalization of the vocal content 704 based on the melody in order to obtain a natural vocal content 706, as depicted in FIG. 7. Since speech units such as phonemes, syllables, etc. appearing in a song have different acoustic characteristics as opposed to those appearing in normal speech (or naturally spoken language), by varying the pitch and/or performing compression/expansion of speech units, the natural vocal content 706 may be obtained. In other words, while the vocal content 704 represents speech information in song-like form, the natural vocal content 706 represents the same speech information in a naturally spoken form.

Subsequently, the natural vocal content 706 may be input to a speech recognizer that may be trained based on naturally spoken language in order to generate a plurality of words 708, or the lyrics, associated with the vocal content 704, as depicted in FIG. 7. In other words, an ensuing advantage of the techniques disclosed herein is that a conventional speech recognizer may be used in order to automatically generate lyrics from the music file due to the pitch normalization being performed on the vocal content 704. The speech recognizer may be trained to identify multiple naturally spoken languages. The speech recognizer may also be trained to identify slang.

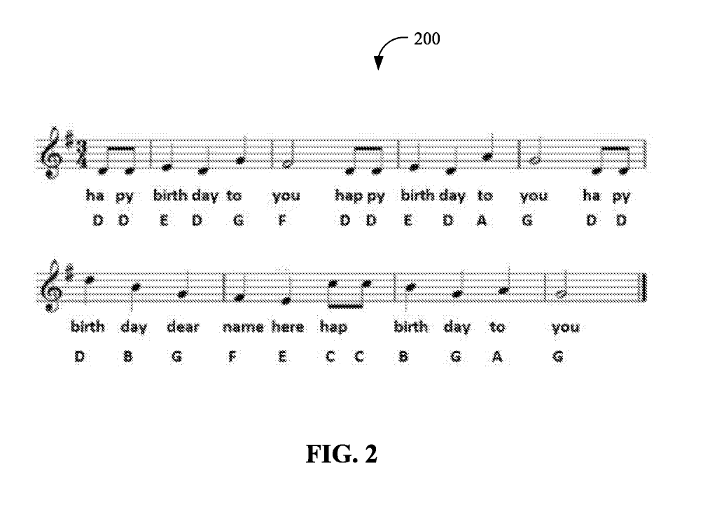

Thereafter, the plurality of words 708 may be used to generate a lyric time code 710, as depicted in FIG. 7, wherein the lyric time code 710 may be transmitted to the computing device 500 of the user 112 for displaying the lyrics. In addition, the platform 100 may include the melody in the lyric time code 710, such that the melody is displayed on the computing device 500 (using standard musical notation) in conjunction with the lyrics, as exemplarily illustrated in FIG. 2. Accordingly, the user 112 may study the melody of the song in relation to the lyrics and learn not only the plurality of words 708 of the song but also the melody of the song. The platform 100 may pre-load the lyric time code 710 onto the computing device 500, such that the lyric time code 710 is launched and played in synch with the song. In other embodiments, the platform 100 may updated and/or transmit the lyric time code 710 to the computing device 500 in real-time, as the lyric time code 710 is generated.

In addition, users may be presented with advertisements (for example, banner images) along with the display of the lyrics and/or the melody. Advertisements may be dynamically selected by analyzing the plurality of words 708 derived from the vocal content 704, wherein an advertisement that corresponds to one or more of the plurality of words 708 is displayed. A database of advertisements may be stored on, or be otherwise made accessible to, the platform 100, wherein each advertisement is tagged with one or more words or phrases. If the platform 100 identifies the one or more words or phrases in the lyric time code 710, then the platform 100 pulls the corresponding advertisement from the database and displays the corresponding advertisement on the computing device 500.

Further, in some embodiments, the user 112 may be required to provide a fee to the platform 100 in order to generate and/or distribute lyrics. In some embodiments, the platform 100 may charge the user 112 a fee per song processed. In other embodiments, the platform 100 may charge the user 112 a recurring fee, such as a monthly fee or a yearly fee. In other embodiments, the platform 100 may charge the user 112 a fee that is determined by the duration of the song. In yet other embodiments, the platform 100 may charge the user 112 a fee that is determined by the word count of the song. In other embodiments, the platform 100 may charge the user 112 a one-time licensing fee.

Additionally, the platform 100 may be configured to publish the lyric time code 710, or the plurality of words 708 forming the lyrics within the lyric time code 710, to a plurality of other users and obtain feedback with regard to correctness of the lyrics. Accordingly, other users may flag one or more of the plurality of words 708 as being incorrect and/or doubtful. Subsequently, the platform 100 may receive the feedback and identify the one or more plurality of words 708. Thereafter, a portion of the vocal content 704 corresponding to the one or more plurality of words 708 may be identified and spliced from the music file. The portion of the vocal content 704 may then be presented to one or more human reviewers along with the one or more plurality words and associated feedback. Accordingly, the human reviewers may be enabled to fix any errors that may be present in the lyrics automatically generated by the platform 100. Alternatively, and/or additionally, the platform 100 may search for one or more pre-existing versions of the lyrics on various online sources. Further, the platform 100 may be configured to validate accuracy of the lyrics generated by the platform 100 by comparing the lyrics to one or more pre-existing versions. Furthermore, in some instances, only a portion of the lyrics (such as the one or more words flagged by users) may be compared with the one or more pre-existing versions.

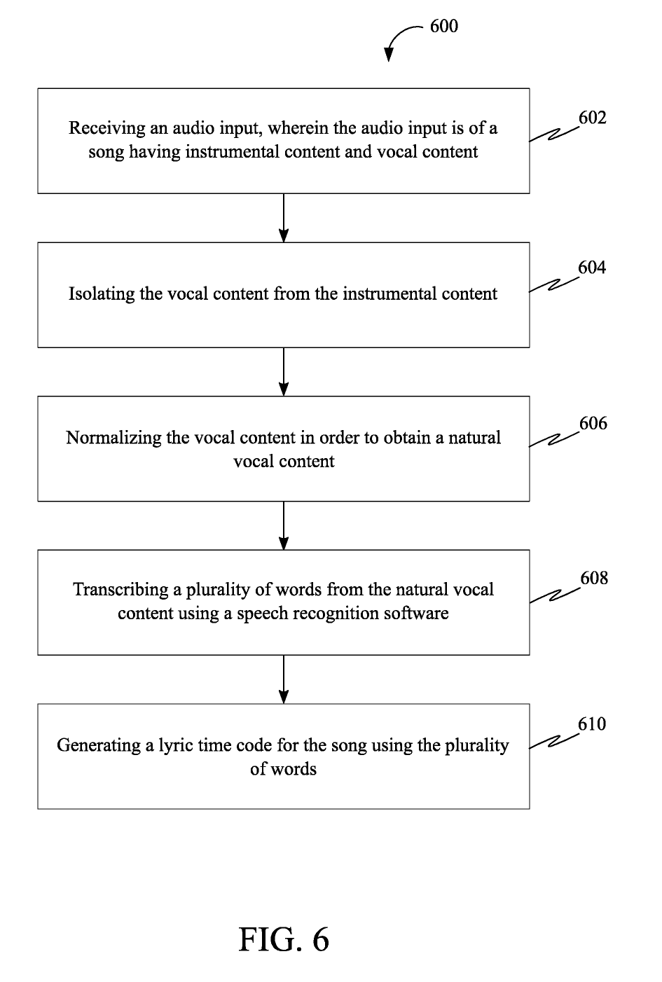

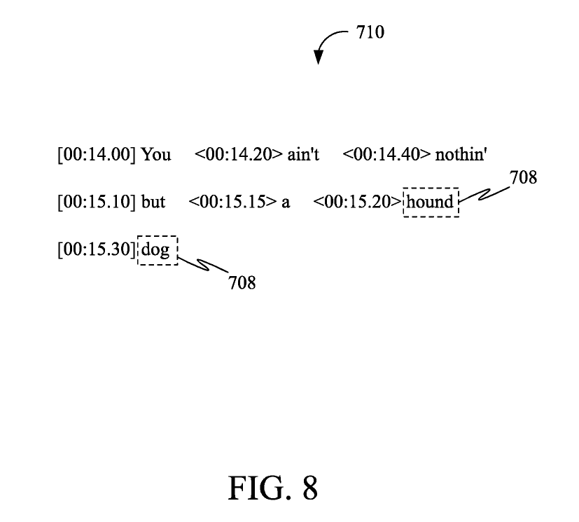

FIG. 6 is a flowchart of a method 600 of automatically generating lyrics of a song, in accordance with some embodiments. The method 600 may include a step 602 of receiving, using the computing device 500, an audio input 700 of a song, wherein the song has instrumental content 702 and vocal content 704. Further, the method 600 may include a step 604 of isolating, using a processing device, the vocal content 704 from the instrumental content 702. Furthermore, the method 600 may include a step 606 of normalizing, using the processing device, the vocal content 704 in order to obtain a natural vocal content 706. Further, the method 600 may include a step 608 of transcribing, using the processing device, a plurality of words 708 from the natural vocal content 706 using a speech recognition software. Accordingly, the speech recognition software may be selected from a plurality of speech recognizers trained on speech data. Furthermore, the method 600 may include a step 610 of generating, using the processing device, a lyric time code 710 for the song using the plurality of words 708. FIG. 8 illustrates the lyric time code 710 generated by the computing device 500 in an exemplary embodiment.

The following provides exemplary means by which the computing device 500 may acquire the audio file in the step 602. The audio input 700 may be an audio file, wherein the audio file may be stored on the computing device 500 or another computing device with which the computing device 500 is communicably coupled. The audio file may be selected manually by the user 112, automatically by the software program of the platform 100, automatically by another music software program, etc. Alternatively, the audio input 700 may be a link to a source of the audio file online, such as a hyperlink containing the uniform resource locator (URL) of a music streaming webpage. As yet another alternative, the computing device 500 may acquire the audio input 700 through a microphone of the computing device 500, wherein the audio file is played through the speaker of either the computing device 500, another computing device, or radio or similar device.

The following provides exemplary means by which the processing device may isolate the vocal content 704 from the instrumental content 702 in the step 604. The processing device may be part of a source separation framework based on advanced signal processing and machine learning technologies that is used to provide an isolation artificial intelligence (AI). The isolation AI may be in the form of deep neural networks that reference an expansive library of files in order to identify the song characteristics of voice and vocal melody. In this way, the isolation AI can discern when vocals are present in a music file, in addition to the pitch of the vocals. The processing device may then use separation algorithms derived from the isolation AI to produce an adaptive filter that is applied to the audio input 700 in order to extract the vocal content 704. The vocal content 704 extracted by the source separation framework may include the complex spectrum of the human voice, including both the harmonic content of the vowels and the noisy components of the consonants. Alternatively, the processing device may identify whether the audio file comprises a single track or multiple tracks. If the audio file comprises multiple tracks, then the processing device may extract the vocal content 704 by retrieving the track corresponding to the vocal content 704. If the audio file comprises a single track, then the processing device may perform separation of the vocal content 704 from the instrumental content 702 based on acoustic characteristics. This may include reducing the volume of the instrumental content 702 within the single track.

The following provides exemplary means by which the processing device may normalize the vocal content 704 in order to obtain the natural vocal content 706 in the step 606. A normalization AI that is either a part of or separate from the source separation framework may be used to normalize the vocal content 704 and obtain the natural vocal content 706. The normalization AI may be in the form of deep neural networks that reference an expansive library of files in order to identify the pitch of vocals. The processing device may then use normalization algorithms derived from the normalization AI to produce a monotone filter that is applied to the vocal content 704 in order to obtain the natural vocal content 706. The normalization AI may identify the pitch of a plurality of notes of the vocal content 704, wherein the plurality of notes may be stored for future use. Alternatively, the processing device may identify the pitch of each of the plurality of notes of the vocal content 704. The processing device may then convert each of the plurality of notes to the key of C, thus obtaining the natural vocal content 706. The plurality of notes of the vocal content 704 may be stored in temporary memory, wherein the pitch of each of the plurality of notes may be stored in the lyric time code 710.

Once the lyric time code 710 has been generated in the step 610, the lyric time code 710 may be utilized in a number of ways with the audio input 700 or the audio file. In some embodiments, the computing device 500 may output the lyric time code 710 in real-time while the song is played, wherein each of the plurality of words 708 is simultaneously stored within the lyric time code 710 and displayed by the computing device 500. In this way, lyrics are generated and displayed to the user 112 in real-time, as the song is processed by the platform 100. The computing device 500 may display the lyrics on a display screen of the computing device 500 or another computing device communicably coupled to the computing device 500. In other embodiments, the computing device 500 may store the lyric time code 710 and the audio file of the song in a folder, wherein the lyric time code 710 may be accessed by a music software player to display the lyrics when the song is played through the music software player. In yet other embodiments, the instrumental content 702 may be stored when performing the step 604 of isolating the vocal content 704 from the instrumental content 702. The lyric time code 710 may then be stored with the instrumental content 702 in a folder, wherein the lyric time code 710 may be accessed by a music software player to display the lyrics while the instrumental content 702 is played through the music software player, thus creating a karaoke style track. The karaoke style track may also be generated and played in real-time, wherein each of the plurality of words 708 is simultaneously stored within the lyric time code 710 and displayed by the computing device 500 as the instrumental content 702 is played.

Once the step 610 of generating the lyric time code 710 has been completed, the lyric time code 710 may be verified for accuracy of the plurality of words 708 derived from the vocal content 704. In some embodiments, the computing device 500 may retrieve pre-existing lyrics for the song from a third-party database. The computing device 500 may then compare the lyric time code 710 to the pre-existing lyrics to determine the accuracy of the lyric time code 710. More specifically, the computing device 500 may sequentially compare each of the plurality of words 708 within the lyric time code 710 to the words of the pre-existing lyrics. If the computing device 500 detects a discrepancy between the plurality of words 708 and the words of the pre-existing lyrics, then a portion of the lyric time code 710, such as the one or more discrepant words, may be flagged by the computing device 500 for further review. The pre-existing lyrics, or the discrepant portion of the pre-existing lyrics, may also be saved by the computing device 500 to be further compared to the lyric time code 710.

In some embodiments, the lyric time code 710 may be shared with the plurality of other users to obtain feedback with regard to the correctness of the lyric time code 710. Accordingly, each of the plurality of other users may provide user feedback by flagging one or more of the plurality of words 708 as being incorrect and/or doubtful. Subsequently, the computing device 500 receives the user feedback for one or more of the plurality of words 708 and identifies the one or more plurality of words 708 within the lyric time code 710. The computing device 500 may then flag the portion of the lyric time code 710 containing the one or more plurality of words 708 identified by the user feedback for further review. Thereafter, a portion of the vocal content 704 corresponding to the one or more plurality of words 708 may be identified and spliced from the audio file. The portion of the vocal content 704 may then be presented to one or more human reviewers along with the one or more plurality words and the user feedback. Accordingly, the human reviewers may be enabled to fix any errors that may be present in the lyric time code 710, wherein the computing device 500 receives a replacement word for a selected word from the plurality of words 708. The computing device 500 then replaces the selected word with the replacement word within the lyric time code 710. Alternatively, the computing device 500 may be configured to determine the most probable lyrics from the user feedback and update the lyric time code 710 accordingly. The computing device 500 may determine the replacement word by aggregating the user feedback and isolating one or more common responses proposed for the selected word. Alternatively, the computing device 500 may be enabled to retrieve pre-existing lyrics as described above, wherein the computing device 500 compares the lyric time code 710 with both the user feedback and the pre-existing lyrics. The computing device 500 may then be configured to determine the most probable lyrics and update the lyric time code 710 accordingly.

The platform 100 may also be utilized to generate a dynamic output 800 that is presented alongside the lyric time code 710 as the song is played. The platform 100 may have access to one or more image databases, wherein each of the one or more image databases may be stored on the computing device 500 or a third-party computing device. Each image within the one or more databases is associated with one or more keywords. The computing device 500 may cross check each of the plurality of words 708 with the one or more databases, and when one of the plurality of words 708 is matched to one of the one or more keywords, the computing device 500 retrieves the associated image. The computing device 500 may cross check the plurality of words 708 with the one or more databases as each of the plurality of words 708 is extracted from the vocal content 704 or after the lyric time code 710 has been generated. The associated image may then be displayed in real-time while the song is played or stored in a file associated with the lyric time code 710 and the audio file. The file may also contain images associated with other keywords, wherein each image may be synchronized with each corresponding keyword such that a dynamic video is formed that can be presented as the song is played. Alternatively, the computing device 500 may have a database of keywords, wherein each of the keywords may be associated with one or more images stored in one or more image databases. When the computing device 500 identifies a keyword from the plurality of words 708, the computing device 500 retrieves at least one of the one or more images associated with the keyword from the one or more databases. The computing device 500 may then display the one or more images corresponding to the keyword in real-time while the song is played or stored in a folder associated with the lyric time code 710 and the audio file. The computing device 500 may be configured to randomly select one of the images from the file when the keyword is sung during playback of the song.

The platform 100 may utilize a dynamic visualization AI that is used to analyze the plurality of words 708 within the lyric time code 710 and generate or retrieve an image or video file that corresponds to the vocal content 704. The dynamic visualization AI may be trained using deep neural networks to identify parts of speech such as nouns, verbs, adjectives, prepositions, etc. The dynamic visualization AI may also be trained using deep neural networks to identify the parts of a sentence such as subjects, predicates, objects, complements, etc. The dynamic visualization AI may also be trained using deep neural networks to identify components of language such as phonemes, morphemes, lexemes, syntax, context, etc. Using algorithms, filters, or data and other functions derived from the dynamic visualization AI, the computing device 500 may be able to generate the dynamic output 800 that can be displayed as the song is played and stored in conjunction with the audio file and lyric time code 710. The dynamic output 800 may include pre-existing images or videos that are retrieved and arranged by the computing device 500. Alternatively, the computing device 500 may be configured to generate original images or videos to be include as part of the dynamic output 800.

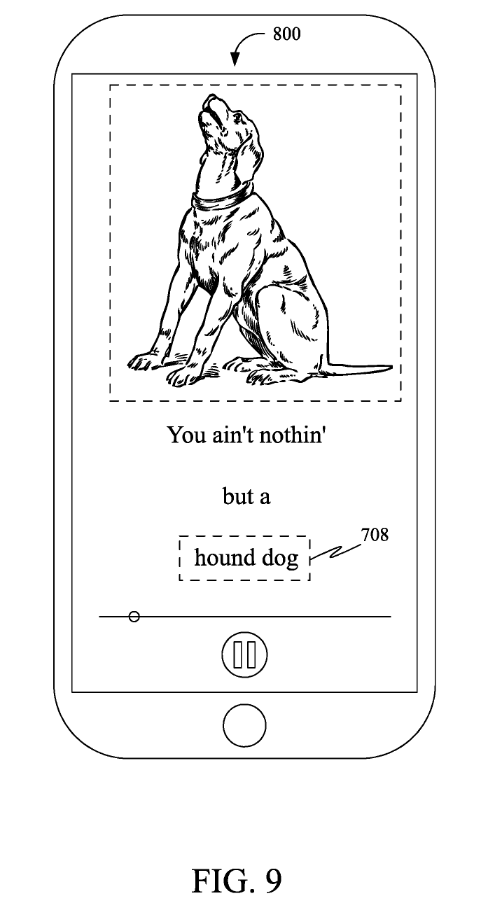

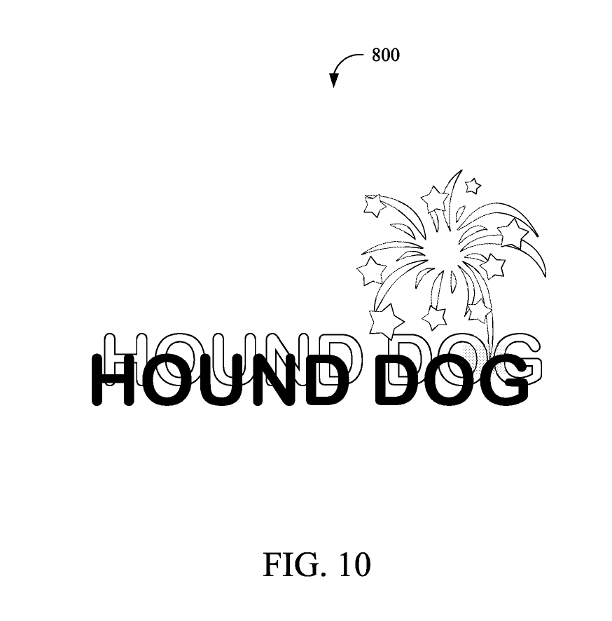

In an exemplary embodiment, the computing device 500 may be configured to dynamically display the plurality of words 708 obtained from the vocal content 704, while simultaneously playing the song. For example, the vocal content 704 may include the line “You ain't nothin' but a hound dog”, wherein the computing device generates a custom display of each of the words in the line: a first image or video being generated for the word “You”, a second image or video being generated for the word “ain't”, and so on. The computing device 500 may have the ability to change the color, font, size, and other visual characteristics as the words are generated into an image or video. Alternatively, the computing device 500 may identify the words “hound dog” from the line “You ain't nothin' but a hound dog” and retrieve an image or video relating to a hound dog, as depicted in FIG. 9. Alternatively, the computing device 500 may identify the words “hound dog” from the line “You ain't nothin' but a hound dog” and generate a visual representation of the words “hound dog”, as depicted in FIG. 10.

The platform 100 may also utilize an AI to discern characteristics of either the vocal content 704 or the instrumental content 702 to assist in generating the dynamic output 800. For example, the AI could be trained using deep neural networks to identify the genre of the song (e.g. rock, hip-hop), the era of the song (e.g. 70's, 80's), the artist of the song, etc. The characteristics of the vocal content 704 and/or the instrumental content 702 discerned by the AI can then be used to influence the style of the images or videos that are retrieved or generated by the computing device 500. For example, the user 112 may play the audio file for “Hound Dog”, wherein the computing device may discern that audio file is for the version of “Hound Dog” by Elvis Presley recorded in 1956. The computing device 500 may then implement visual characteristics associated with Elvis Presley and/or the 1950's into the visualization of the vocal content 704 for the song.

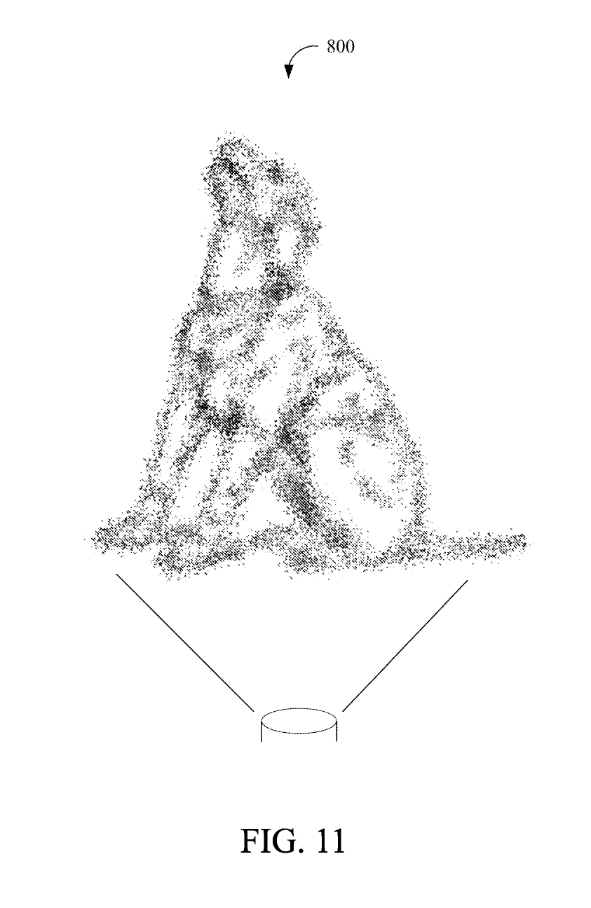

In some embodiments, the platform may be communicably coupled with additional hardware to generate additional media forms for the dynamic output 800. For example, in some embodiments, the computing device 500 may be communicably coupled to hardware that is able to produce holograms. As such, the computing device 500 may be configured to generate or retrieve files that can be read by the hardware in order to produce holograms that are associated with the vocal content 704 of the song, as depicted in FIG. 11. As another exemplary embodiment, the computing device 500 may be communicably coupled to a three dimensional (3D) printer, wherein the computing device 500 is configured to generate or retrieve 3D printing files. A 3D representation of the vocal content 704 may then be printed in real-time as the song is played, or printed at another time.

In order to generate revenue, the platform 100 may include the display of advertisements along with the lyric time code 710. The advertisements may include static images or video content. The advertisements may be dynamically selected by the computing device 500 by analyzing the plurality of words 708 derived from the vocal content 704, wherein an advertisement that corresponds to one or more of the plurality of words 708 is displayed. The computing device 500 may also analyze the instrumental content 702 in order to determine an appropriate style of advertisement to display. A database of advertisements may be stored on or be otherwise made accessible to the computing device 500, wherein each advertisement is tagged with one or more words or phrases. If the computing device 500 identifies the one or more words or phrases in the lyric time code 710, then the computing device 500 pulls the corresponding advertisement from the database and displays the corresponding advertisement on the computing device 500. Alternatively, the computing device 500 may use machine learning to identify characteristics of the vocal content 704 and/or the instrumental content 702 in a larger context of the overall song in order to select and display an appropriate advertisement. For example, rather than identifying the word “dog” and displaying an advertisement for dog products, the computing device 500 may be trained to understand that the use of the word “dog” within the context of the rest of the vocal content 704 has a different meaning, and thus is able to display a more relevant advertisement to the song.

Further, the computing device 500 may be configured to determine an advertising value for the song based on a trending songs list. For example, the trending songs list may include songs featured on the “Hot 100” chart or the “Greatest of All Time Hot 100 Songs” chart, wherein the songs may demand a higher advertisement fee compared to songs not featured on the aforementioned charts. Furthermore, the computing device 500 may be configured to determine the advertising value based on tiers within a chart. For example, songs featured in the “Hot 100” chart may be separated into tier 1 containing songs 1-33, tier 2 containing songs 33-66, and tier 3 containing songs 67-100, wherein the advertising value is increased from tier 3 to tier 1. Once the computing device 500 has determined the advertisement value for the song, the computing device 500 may retrieve and display an advertisement corresponding to the advertisement value. The computing device 500 may also be configured to determine the advertising value according to other factors such specific artists, record labels, etc.

In some embodiments, the platform 100 may be provided with a database of censored words. The computing device 500 may cross check each of the plurality of words 708 with the database of censored words, and when one of the plurality of words 708 is matched to a censored word within the database of censored words, the computing device 500 flags the word. The computing device 500 may cross check the plurality of words 708 with the database of censored words as each of the plurality of words 708 is extracted from the vocal content 704 or after the lyric time code 710 has been generated. The computing device 500 may then omit the word from the lyric time code 710 or replace the word with a substitute word. The computing device 500 may also be configured to mute the word within the vocal content 704 such that the word is not heard when the audio file is played.

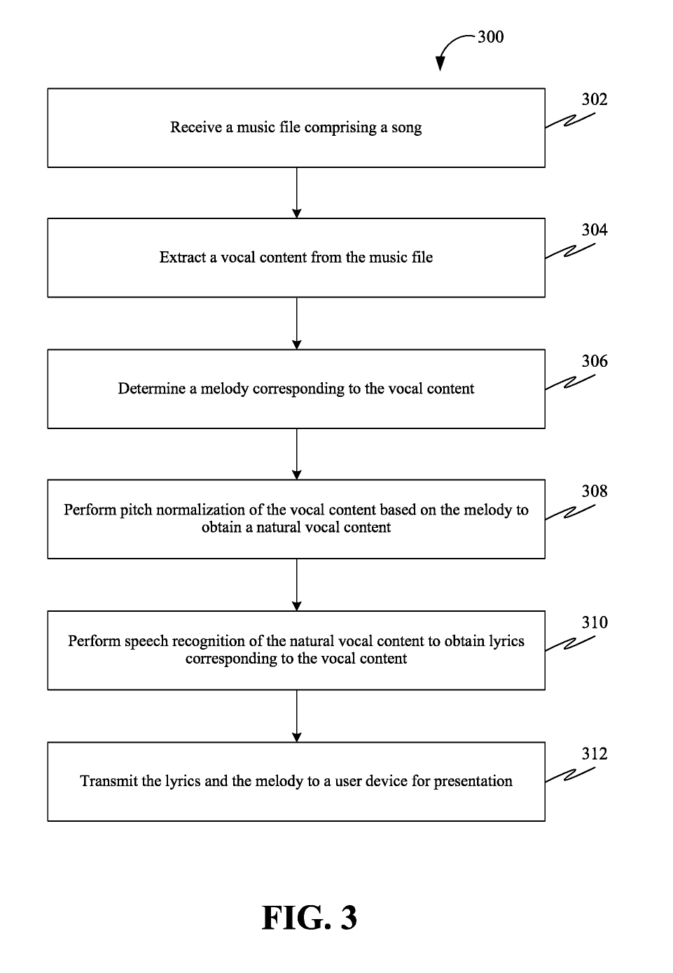

FIG. 3 is a flowchart of a method 300 of automatically generating lyrics of a song, in accordance with some embodiments. The method 300 may include a step 302 of receiving, using the computing device 500, a music file comprising a song. Further, the method 300 may include a step 304 of extracting, using a processing device, a vocal content 704 from the music file. Furthermore, the method 300 may include a step 306 of determining, using the processing device, a melody corresponding to the vocal content 704. Additionally, the method 300 may include a step 308 of performing, using the processing device, pitch normalization of the vocal content 704 based on the melody to obtain a natural vocal content 706. Further, the method 300 may include a step 310 of performing, using the processing device, speech recognition of the natural vocal content 706 to obtain lyrics corresponding to the vocal content 704. Furthermore, the method 300 may include a step 312 of transmitting, using the communication device, the lyrics and the melody to a user device for presentation.

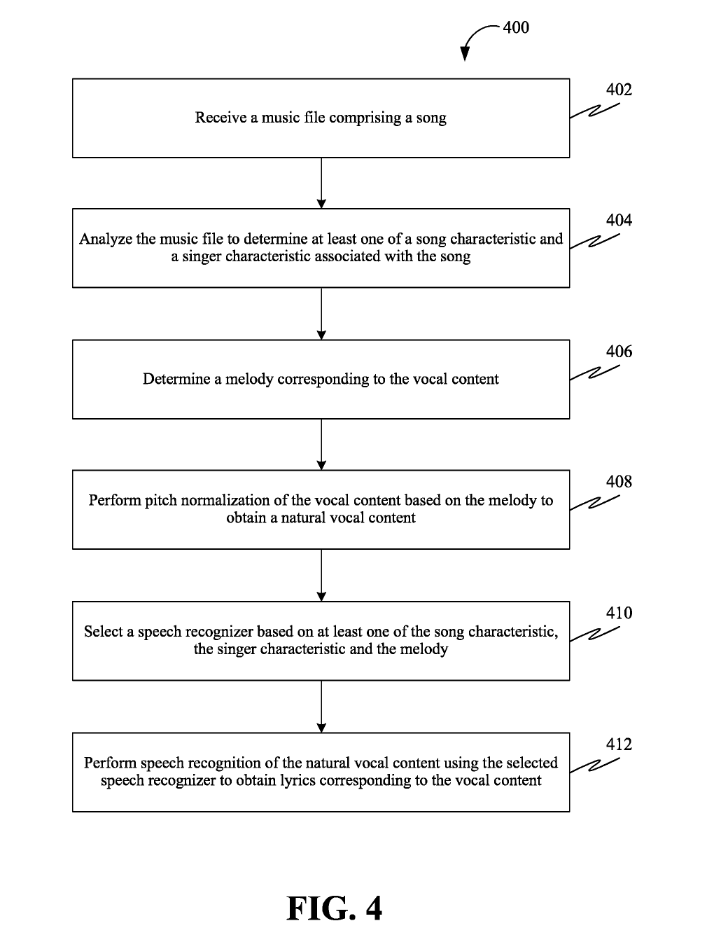

FIG. 4 is a flowchart of a method 400 of automatically generating lyrics of a song based on at least one of a song characteristic and a singer characteristic, in accordance with some embodiments. The method 400 may include a step 402 of receiving, using the computing device 500, a music file comprising a song. Further, the method 400 may include a step 404 of analyzing, using the processing device, the music file to determine at least one of a song characteristic and a singer characteristic associated with the song. Furthermore, the method 400 may include a step 406 of determining, using the processing device, a melody corresponding to the vocal content 704. Additionally, the method 400 may include a step 408 of performing, using the processing device, pitch normalization of the vocal content 704 based on the melody to obtain a natural vocal content 706. Further, the method 400 may include a step 410 of selecting, using the processing device, a speech recognizer based on at least one of the song characteristic, the singer characteristic and the melody. Accordingly, the selecting may be performed from a plurality of speech recognizers trained on speech data corresponding to at least one of the song characteristic, the singer characteristic and the melody. Furthermore, the method 400 may include a step 412 of performing, using the processing device, speech recognition of the natural vocal content 706 using the selected speech recognizer to obtain lyrics corresponding to the vocal content 704. As a result of using speech recognizers specially adapted to at least one of the song characteristic, the singer characteristic and the melody, a greater degree of accuracy may be achieved in generating the lyrics.

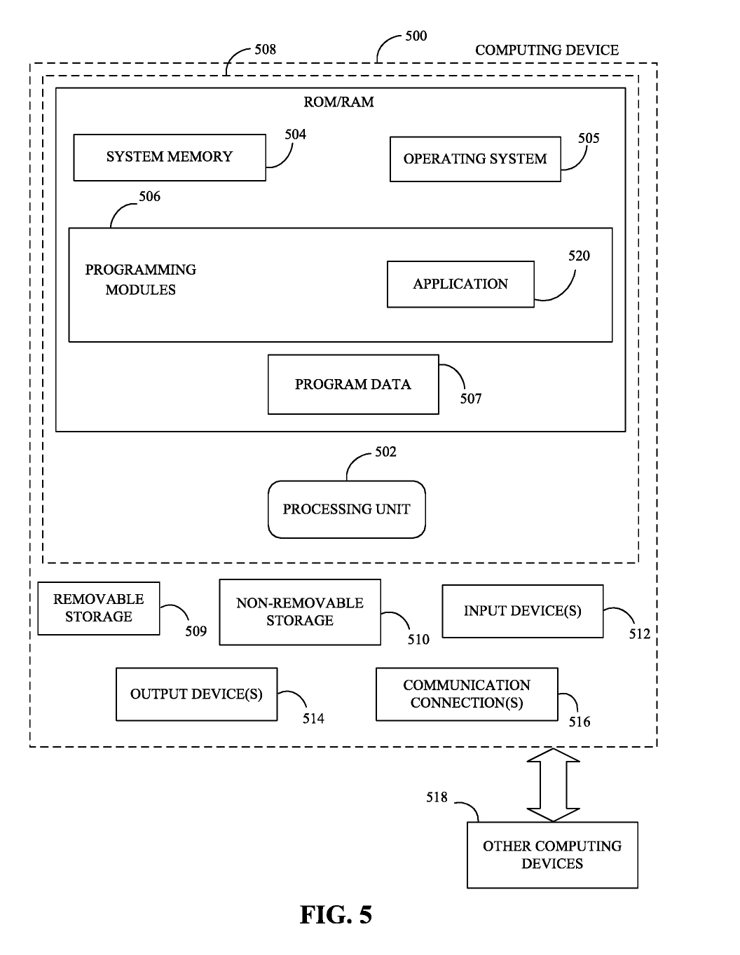

FIG. 5 is a block diagram of a system including the computing device 500. Consistent with an embodiment of the disclosure, the aforementioned storage device and processing device may be implemented in a computing device, such as the computing device 500 of FIG. 5. Any suitable combination of hardware, software, or firmware may be used to implement the memory storage and processing unit. For example, the storage device and the processing device may be implemented with the computing device 500 or any of other computing devices 518, in combination with the computing device 500. The aforementioned system, device, and processors are examples, and other systems, devices, and processors may comprise the aforementioned storage device and processing device, consistent with embodiments of the disclosure.

With reference to FIG. 5, a system consistent with an embodiment of the disclosure may include a computing device or cloud service, such as the computing device 500. In a basic configuration, the computing device 500 may include at least one processing unit 502 and a system memory 504. Depending on the configuration and type of computing device, the system memory 504 may comprise, but is not limited to, volatile (e.g. random access memory (RAM)), non-volatile (e.g. read-only memory (ROM)), flash memory, or any combination thereof. The system memory 504 may include an operating system 505, one or more programming modules 506, and may include a program data 507. The operating system 505, for example, may be suitable for controlling computing device 500's operation. In one embodiment, programming modules 506 may include an image encoding module, a machine learning module and an image classifying module. Furthermore, embodiments of the disclosure may be practiced in conjunction with a graphics library, other operating systems, or any other application program and is not limited to any particular application or system. This basic configuration is illustrated in FIG. 5 by those components within a dashed line 508.

The computing device 500 may have additional features or functionality. For example, the computing device 500 may also include additional data storage devices (removable and/or non-removable) such as, for example, magnetic disks, optical disks, or tape. Such additional storage is illustrated in FIG. 5 by a removable storage 509 and a non-removable storage 510. Computer storage media may include volatile and nonvolatile, removable and non-removable media implemented in any method or technology for storage of information, such as computer-readable instructions, data structures, program modules, or other data. The system memory 504, the removable storage 509, and the non-removable storage 510 are all computer storage media examples (i.e., memory storage). Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by the computing device 500. Any such computer storage media may be part of the computing device 500. The computing device 500 may also have one or more input devices 512 such as a keyboard, a mouse, a pen, a sound input device, a touch input device, etc. One or more output devices 514 such as a display, speakers, a printer, etc. may also be included as part of the computing device 500. The aforementioned devices are examples and others may be used.

The computing device 500 may also contain a communication connection 516 that may allow the computing device 500 to communicate with the other computing devices 518, such as over a network in a distributed computing environment, for example, an intranet or the Internet. The communication connection 516 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in the system memory 504, including the operating system 505. While executing on the processing unit 502, the programming modules 506 (e.g., application 520 such as a media player) may perform processes including, for example, one or more stages of the methods 600, 300, and 400 as described above. The aforementioned processes are an example, and the processing unit 502 may perform other processes. Other programming modules that may be used in accordance with embodiments of the present disclosure may include sound encoding/decoding applications, machine learning applications, acoustic classifiers, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the invention has been explained in relation to its preferred embodiment, it is to be understood that many other possible modifications and variations can be made without departing from the spirit and scope of the invention as hereinafter claimed.

What is claimed is:

1. A method for automatically generating the lyrics of a song by executing computer-executable instructions stored on a non-transitory computer readable medium, the method comprises the steps of:
receiving an audio input, wherein the audio input is of a song having instrumental content and vocal content;
isolating the vocal content from the instrumental content;
normalizing the vocal content in order to obtain a natural vocal content;
transcribing a plurality of words from the natural vocal content using a speech recognition software; and
generating a lyric time code for the song using the plurality of words.

2. The method for automatically generating the lyrics of a song by executing computer-executable instructions stored on a non-transitory computer readable medium, the method as claimed in claim 1 further comprises the steps of:
outputting the lyric time code in real-time while the song is played.

3. The method for automatically generating the lyrics of a song by executing computer-executable instructions stored on a non-transitory computer readable medium, the method as claimed in claim 1 further comprises the steps of:
storing the lyric time code along with an audio file of the song.

4. The method for automatically generating the lyrics of a song by executing computer-executable instructions stored on a non-transitory computer readable medium, the method as claimed in claim 1 further, wherein the audio input is an audio file.

5. The method for automatically generating the lyrics of a song by executing computer-executable instructions stored on a non-transitory computer readable medium, the method as claimed in claim 1 further, wherein the audio input is received through a microphone.

6. The method for automatically generating the lyrics of a song by executing computer-executable instructions stored on a non-transitory computer readable medium, the method as claimed in claim 1 further comprises the steps of:
outputting the lyric time code in real-time while simultaneously outputting the instrumental content.

7. The method for automatically generating the lyrics of a song by executing computer-executable instructions stored on a non-transitory computer readable medium, the method as claimed in claim 1 further comprises the steps of:
identifying a keyword from the plurality of words; and
displaying an image corresponding to the keyword.

8. The method for automatically generating the lyrics of a song by executing computer-executable instructions stored on a non-transitory computer readable medium, the method as claimed in claim 1 further comprises the steps of:
displaying an advertisement corresponding to one or more of the plurality of words.

9. The method for automatically generating the lyrics of a song by executing computer-executable instructions stored on a non-transitory computer readable medium, the method as claimed in claim 1 further, wherein the speech recognition software is able to discern more than one language.

10. The method for automatically generating the lyrics of a song by executing computer-executable instructions stored on a non-transitory computer readable medium, the method as claimed in claim 1 further comprises the steps of:
reducing the volume of the instrumental content.

11. The method for automatically generating the lyrics of a song by executing computer-executable instructions stored on a non-transitory computer readable medium, the method as claimed in claim 1 further comprises the steps of:
identifying the pitch of each of a plurality of notes of the vocal content.

12. The method for automatically generating the lyrics of a song by executing computer-executable instructions stored on a non-transitory computer readable medium, the method as claimed in claim 11 further comprises the steps of:
storing the plurality of notes in temporary memory.

13. The method for automatically generating the lyrics of a song by executing computer-executable instructions stored on a non-transitory computer readable medium, the method as claimed in claim 11 further comprises the steps of:
converting each of the plurality of notes to the key of C.

14. The method for automatically generating the lyrics of a song by executing computer-executable instructions stored on a non-transitory computer readable medium, the method as claimed in claim 11 further comprises the steps of:
storing the pitch of each of the plurality of notes in the lyric time code.

15. The method for automatically generating the lyrics of a song by executing computer-executable instructions stored on a non-transitory computer readable medium, the method as claimed in claim 1 further comprises the steps of:
receiving a replacement word for a selected word from the plurality of words; and
replacing the selected word with the replacement word within the lyric time code.

16. The method for automatically generating the lyrics of a song by executing computer-executable instructions stored on a non-transitory computer readable medium, the method as claimed in claim 1 further comprises the steps of:
retrieving pre-existing lyrics for the song from a third-party database; and
comparing the lyric time code to the pre-existing lyrics to determine the accuracy of the lyric time code.

17. The method for automatically generating the lyrics of a song by executing computer-executable instructions stored on a non-transitory computer readable medium, the method as claimed in claim 1 further comprises the steps of:
receiving user feedback for one or more of the plurality of words; and
flagging the one or more plurality of words for review.

18. The method for automatically generating the lyrics of a song by executing computer-executable instructions stored on a non-transitory computer readable medium, the method as claimed in claim 1 further comprises the steps of:
determining an advertising value for the song based on a trending song list; and
displaying an advertisement corresponding to the advertising value.

19. The method for automatically generating the lyrics of a song by executing computer-executable instructions stored on a non-transitory computer readable medium, the method as claimed in claim 1 further comprises the steps of:
dynamically displaying the plurality of words while simultaneously playing the song.
